(19) United States
(12) Patent Application Publication
(10) Pub. No.: US 2021/0377402 A1
(43) Pub. Date: Dec. 2, 2021

(54) CONTROL PANEL, IMAGE FORMING APPARATUS, AND NON-TRANSITORY RECORDING MEDIUM

(71) Applicant: Tasuku KOHARA, Tokyo (JP)

(72) Inventor: Tasuku KOHARA, Tokyo (JP)

(73) Assignee: Ricoh Company, Ltd., Tokyo (JP)

(21) Appl. No.: 17/314,266

(22) Filed: May 7, 2021

(30) Foreign Application Priority Data
Jun. 2, 2020 (JP) 2020-096483

(51) Int. Cl. H04N 1/00; G06F 3/12; G06F 3/041

(52) U.S. Cl. CPC H04N 1/00411; G06F 3/0412; G06F 3/1279

(57) ABSTRACT

A control panel, an image forming apparatus, and a non-transitory recording medium. The control panel determines whether a contact operation performed on the operation screen in an energy saving mode in which power supply to a part of the control panel is stopped, is a contact operation for instructing a return from the energy saving mode to a normal mode for operating the device, or a contact operation for cleaning the touch panel, based on a determination that the contact operation is a contact operation for instructing the return to the normal mode, displays the operation screen and return the device to an operating state, and based on a determination that the contact operation is a contact operation for cleaning foreign material on the touch panel, maintains a non-display state of the operation screen.

### CROSS-REFERENCE TO RELATED APPLICATIONS

This patent application is based on and claims priority pursuant to 35 U.S.C. § 119(a) to Japanese Patent Application No. 2020-096483, filed on Jun. 2, 2020, in the Japan Patent Office, the entire disclosure of which is hereby incorporated by reference herein.

### BACKGROUND

### Technical Field

The present disclosure relates to a control panel, an image forming apparatus, and a non-transitory recording medium.

### Related Art

Today, image forming apparatuses such as multifunction peripherals are known. Since a touch panel of the image forming apparatus is touched with a user's finger or the like, fingerprints, sebum stains, and the like adhere on the touch panel. Such foreign material on the touch panel is often noticed when the touch panel is hidden (black screen), for example, in the energy saving mode.

### SUMMARY

Embodiments of the present disclosure describe a control panel, an image forming apparatus, and a non-transitory recording medium. The control panel determines whether a contact operation performed on the operation screen in an energy saving mode in which power supply to a part of the control panel is stopped, is a contact operation for instructing a return from the energy saving mode to a normal mode for operating the device, or a contact operation for cleaning the touch panel, based on a determination that the contact operation is a contact operation for instructing the return to the normal mode, displays the operation screen and return the device to an operating state, and based on a determination that the contact operation is a contact operation for cleaning foreign material on the touch panel, maintains a non-display state of the operation screen.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a perspective view illustrating appearance of a multifunction peripheral (MFP) according to embodiments of the present disclosure;

FIG. 2 is a block diagram illustrating a hardware configuration of the MFP according to a first embodiment of the present disclosure;

FIG. 3 is a cross-sectional view of a touch panel provided in the MFP according to the first embodiment of the present disclosure;

FIG. 4 is a diagram illustrating a detection principle of a contact operation of the touch panel;

FIG. 5 is a block diagram illustrating a hardware configuration of a control panel ;

FIG. 6 is a block diagram illustrating a functional configuration of a second controller of the control panel;

FIG. 7 is a flowchart illustrating a mode control operation executed by the second controller of the control panel according to the first embodiment of the present disclosure;

FIGS. 8A and 8B are diagrams illustrating an operation mode of the MFP when the MFP is returned from an energy saving mode to a normal mode;

FIG. 9 is a diagram illustrating an operation screen when returning from the energy saving mode to the normal mode;

FIGS. 10A and 10B are diagrams illustrating an operation mode of the MFP when cleaning the touch panel of the control panel of the MFP in the energy saving mode;

FIGS. 11A and 11B are diagrams illustrating a contact operation when returning the MFP from the energy saving mode to the normal mode;

FIGS. 12A, 12B, and 12C are diagrams illustrating a contact mode when cleaning the touch panel of the MFP;

FIG. 13 is a diagram illustrating an example of a display screen in a cleaning mode of the MFP according to the first embodiment of the present disclosure;

FIG. 14 is a block diagram illustrating a hardware configuration of the control panel of the MFP according to a second embodiment of the present disclosure;

FIG. 15 is a block diagram illustrating a functional configuration of a second controller of the control panel of the MFP according to the second embodiment of the present disclosure; and

FIG. 16 is a flowchart illustrating the mode control operation executed by the second controller of the control panel according to the second embodiment of the present disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

The terminology used herein is for the purpose of describing particular embodiments only and is not intended to be limiting of the present invention. As used herein, the singular forms “a,” “an,” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, an MFP as an example of an image forming apparatus is described with reference to the attached drawings.

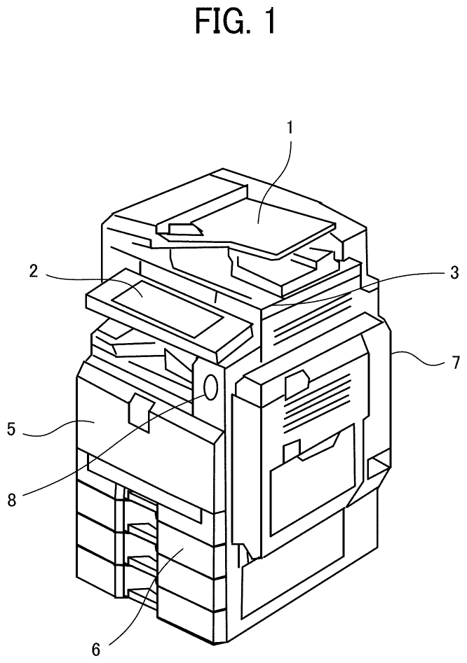

FIG. 1 is a perspective view illustrating appearance of the MFP according to a first embodiment. As illustrated in FIG. 1, the MFP according to the first embodiment includes an automatic document feeder (ADF) 1 that automatically conveys a document to a scanner, a control panel 2 for performing an input operation, the scanner 3 to read a document to be copied, and a printer 5 to print and output a copied image. Further, the MFP includes a paper tray 6 for storing paper, a first controller 7 for controlling the operation of the entire MFP, and a motion sensor 8 for detecting the user within a certain distance from the MFP.

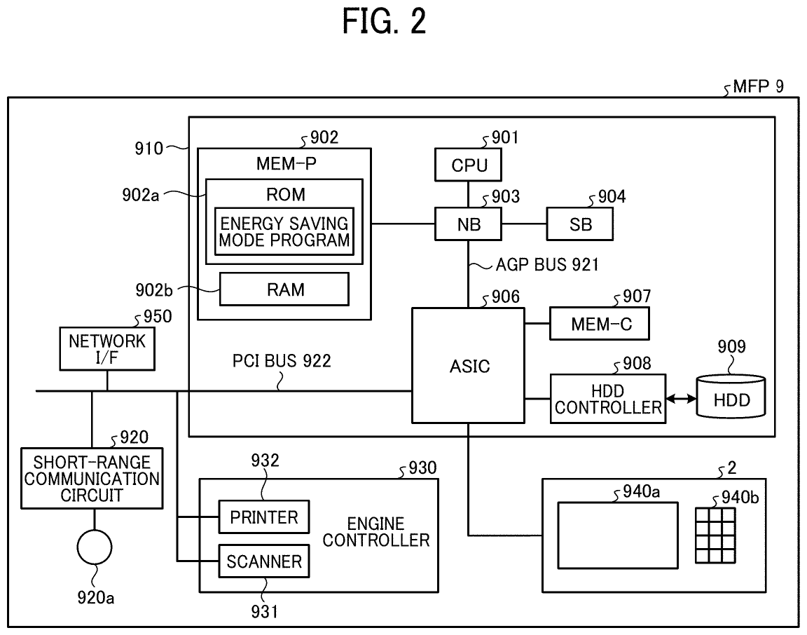

FIG. 2 is a block diagram illustrating a hardware configuration of an MFP 9, as an example of the MFP illustrated in FIG. 1. As illustrated in FIG. 2, the MFP 9 includes a controller 910, a short-range communication circuit 920, an engine controller 930, a control panel 2, and a network interface (I/F) 950.

The controller 910 includes a central processing unit (CPU) 901, a system memory (MEM-P) 902, a north bridge (NB) 903, a south bridge (SB) 904, an Application Specific

Integrated Circuit (ASIC) 906, a local memory (MEM-C) 907, a hard disk drive (HDD) controller 908, and a HDD 909. The NB 903 and the ASIC 906 are connected by an Accelerated Graphics Port (AGP) bus 921.

The CPU 901 is a processor that performs overall control of the MFP 9. The NB 903 is a bridge for connecting the CPU 901, the MEM-P 902, the SB 904, and the AGP bus 921. The NB 903 includes a memory controller that controls reading and writing to the MEM-P 902, a Peripheral Component Interconnect (PCI) master, and an AGP target.

The MEM-P 902 includes a read only memory (ROM) 902a which is a memory for storing a program that implements each function of the memory controller or data, and a RAM 902b used for deploying a program or data. The RAM 902b may be used as a memory for rendering an image at the time of printing using a memory. The program stored in the ROM 902a may be stored in any computer-readable storage medium, such as a compact disc-read only memory (CD-ROM), compact disc-recordable (CD-R), or digital versatile disc (DVD), in a file format installable or executable by the computer for distribution.

The SB 904 connects the NB 903 with a peripheral component interconnect (PCI) device or a peripheral device. The ASIC 906 is an integrated circuit (IC) dedicated to image processing, and connects the AGP bus 921, a Peripheral Component Interconnect (PCI) bus 922, the HDD controller 908, and the MEM-C 907.

The ASIC 906 includes a PCI target, an AGP master, an arbiter (ARB) as a central processor of the ASIC 906, a memory controller for controlling the MEM-C 907. The ASIC 906 also includes a plurality of direct memory access controllers (DMACs) capable of converting coordinates of image data with a hardware logic, and a PCI unit that transfers data between a scanner 931 and a printer 932 through the PCI bus 922. A Universal Serial Bus (USB) interface or an Institute of Electrical and Electronics Engineers (IEEE) 1394 interface may be connected to the ASIC 906.

The MEM-C 907 is a local memory used as a buffer for image data to be copied or a code buffer. The HDD 909 is a storage for storing image data, font data used during printing, and forms. The HDD controller 908 controls the writing and reading of data to the HDD 909 according to the control of the CPU 901. The AGP bus 921 is a bus interface for a graphics accelerator card proposed for speeding up graphics processing. The AGP bus 921 directly accesses the MEM-P 902 with high throughput to accelerate the graphics accelerator card.

The short-range communication circuit 920 is provided with a short-range communication antenna 920a. The short-range communication circuit 920 is a communication circuit that communicates in compliance with Near Field Communication (NFC), BLUETOOTH (registered trademark) and the like. Further, the engine controller 930 includes a scanner 931 and a printer 932 which are examples of an image forming unit.

The control panel 2, as an example of operation unit, includes a touch panel 940a. More specifically, the control panel 2 is provided with a liquid crystal display (LCD) 706 that displays a current set value or selection screen, and the touch panel 940a implemented by a resistive film type touch panel that receives contact input from a user. Since the touch panel 940a is layered on the top of the LCD 706, only the touch panel 940a is illustrated in FIG. 2, for simplicity. Further, the control panel 2 includes a hardware key 940b such as a numeric keypad for inputting a set value of a condition related to image formation such as a density setting condition and a start key for instructing a copy start.

The controller 910 controls the entire MFP 9, for example, rendering control, communication control, input processing from the control panel 2, and the like. The scanner 931 or the printer 932 includes image processing functions such as error diffusion processing and gamma conversion processing.

The ROM 902a, which is an example of a storage unit, stores an energy saving mode program (an example of a mode control program) that controls the transition to or from the energy saving mode, in which power is saved by stopping the power supply to unnecessary parts during the operation standby of the MFP 9.

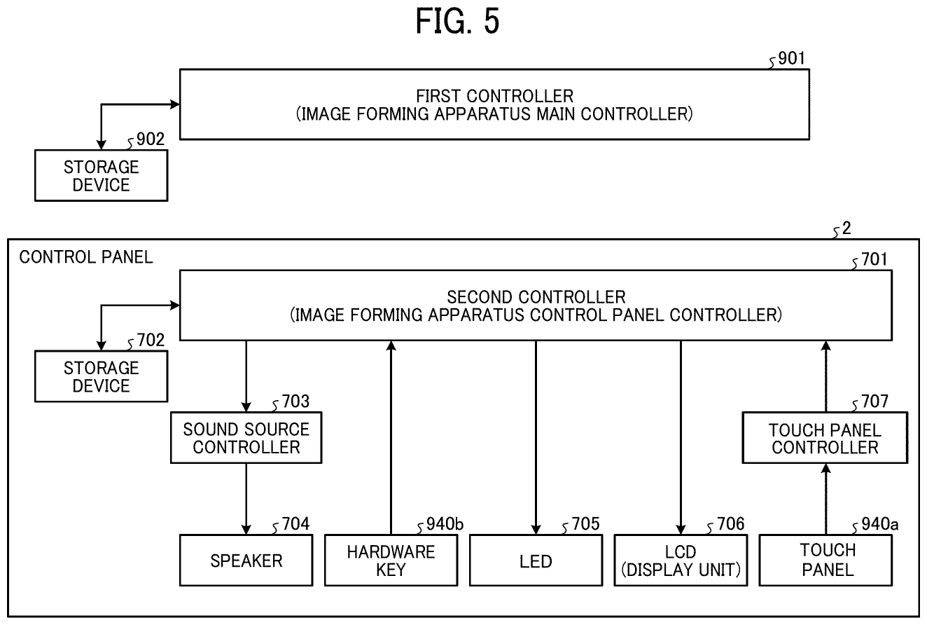

As described below, the control panel 2 is provided with a control unit (second controller 701 illustrated in FIG. 5) different from the CPU 901 of the main body of the MFP 9, and the control panel 2 can be controlled independently from the main body of the MFP 9. Based on the energy saving mode program read from the ROM 902a via the CPU 901, the control unit of the control panel 2 determines whether a touch operation on the touch panel 940a in the energy saving mode is a contact operation for cleaning or a contact operation for instructing a return to the normal mode. Then, depending on determination result, the energy saving mode is maintained or returned to the normal mode. When it is determined that the contact operation is for cleaning, the energy saving mode is maintained without returning to the normal mode. As a result, foreign material, such as foreign material adhering on the touch panel 940a can be easily recognized and the cleaning is assisted.

In response to an instruction to select a specific application through the control panel 2, for example, using a mode switch key, the MFP 9 selectively performs a document box function, a copy function, a print function, and a facsimile function. The MFP 9 is in a document box mode when the document box function is selected and is in a copy mode when the copy function is selected. Further, the MFP 9 is in a printer mode when the printer function is selected and is in a facsimile mode when the facsimile mode is selected.

The network I/F 950 is an interface for performing data communication using a communication network. The short-range communication circuit 920 and the network I/F 950 are electrically connected to the ASIC 906 through the PCI bus 922.

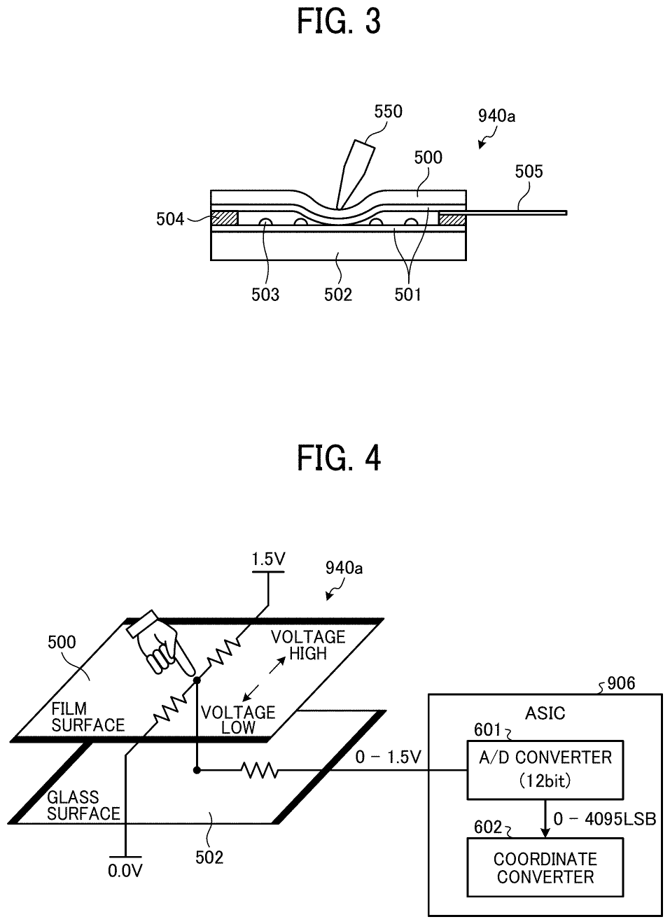

FIG. 3 is a cross-sectional view of the touch panel 940a. As illustrated in FIG. 3, the touch panel 940a is formed by laminating a transparent film 500, multiple layers of indium tin oxide (ITO) films 501, and a glass plate 502 in this order. The ITO film 501 has a uniformly formed resistance component.

Dot spacers 503 are provided between the opposing ITO films 501. The ITO films 501 facing each other are adhered to each other by laminating material 504. A connector tail 505 is pulled out from the ITO film 501 on upper surface side.

In the touch panel 940a, when the transparent film 500 is contacted with a dedicated pen, a finger 550, or the like, the transparent film 500 bends and the upper and lower ITO films 501 come into contact with each other and electrically connected. As a result, an input operation is detected.

In a case of a light load type touch panel, the contact operation can be detected even with a light force by reducing the thickness of the transparent film 500 and devising shape of the dot spacer 503.

FIG. 4 is a diagram illustrating a detection principle of a contact operation of the touch panel 940a. FIG. 4 illustrates the detection principle of the contact operation of a Y coordinate, of an X coordinate and the Y coordinate that are orthogonal to each other in two dimensions. In FIG. 4, when a voltage of, for example, 1.5 V is applied between the electrodes of the transparent film 500, film surface of the transparent film 500 has a voltage distribution of 0 V to 1.5 V. When the film surface of the transparent film 500 is in contact with such as pen or finger in this state, the voltage at a contact point is transmitted to the glass plate 502.

The voltage (0 V to 1.5 V) at the contact point is transmitted to the ASIC 906 including the touch panel control function through the electrode of the glass plate 502. The ASIC 906 converts the voltage at the contact point into, for example, a 12-bit digital value (0 to 4095) by an analog/digital (A/D) converter 601. Further, the ASIC 906 converts the digital value of the voltage of the contact point into the coordinates (LCD coordinates) of the touch panel 940a by a coordinate converter 602.

The contact point of the X coordinate is detected by applying a voltage of, for example, 1.5 V between the electrodes of the glass plate 502 and reading out a voltage of the contact point on the transparent film 500.

As described above, the contact position (coordinates) on the touch panel 940a is detected by supplying voltage values in an X-axis direction and a Y-axis direction corresponding to the contact position to the ASIC 906, performing A/D conversion processing, and converting to the coordinates.

FIG. 5 is a block diagram illustrating a hardware configuration of the control panel 2. As illustrated in FIG. 5, the control panel 2 includes the second controller 701, a storage device 702, a sound source controller 703, a speaker 704, a light emitting diode (LED) 705, the LCD 706 which is a display unit, a touch panel controller 707, the touch panel 940a, and a hardware key 940b.

Further, the MFP 9 includes a first controller 901 (corresponding to the CPU 901 in

FIG. 2) connected to the storage device 902 in the main body. The second controller 701 of the control panel 2 is communicable with the first controller 901, for example, via a communication line.

As described above, in an example of the MFP 9 according to the first embodiment, the control panel 2 is operated by the second controller 701 different from the first controller 901 on the main body of the MFP 9. Therefore, in the case of the MFP 9 according to the first embodiment, display screens can be displayed with contents having rich expressions on, for example, the LCD 706 without directly affecting the copy function, the printer function, the facsimile function, and the like on the main body of the MFP 9. Further, the touch panel 940a can be controlled by the control panel 2, specifically by the touch panel controller 707 and the second controller 701 included in the control panel 2. Alternatively, the control panel 2 may be controlled by the first controller 901.

Further, in the energy saving mode in which power supply to unnecessary parts of the

MFP 9 is stopped during standby to save power, the power supply to the first controller 901 is stopped and only the second controller 701 is activated. Even when the second controller 701 is activated in the energy saving mode, the LED 705 and the LCD 706 are turned off, and only the touch panel 940a is activated to detect the user's contact operation. Therefore, in the energy saving mode, the LCD 706 is in a dark state (a state in which nothing is displayed: an off state), but the contact operation of the user can be detected.

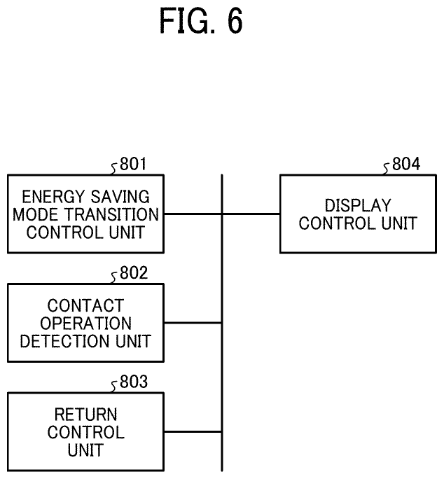

The second controller 701 of the control panel 2 implements each function illustrated in FIG. 6 by operating according to the energy saving mode program read from the storage device 902 (corresponding to ROM 902a in FIG. 2) by the first controller 901 on the main body of the MFP 9. Alternatively, the functions may be implemented by storing the energy saving mode program in the storage device 702 on the control panel 2 and the second controller 701 executing the energy saving mode program stored in the storage device 702.

The second controller 701 functions as an energy saving mode transition control unit 801, a contact operation detection unit 802, a return control unit 803, and a display control unit 804 by executing the energy saving mode program. The second controller 701 functions as the energy saving mode transition control unit 801, the contact operation detection unit 802, the return control unit 803, and the display control unit 804 to perform the mode control described below.

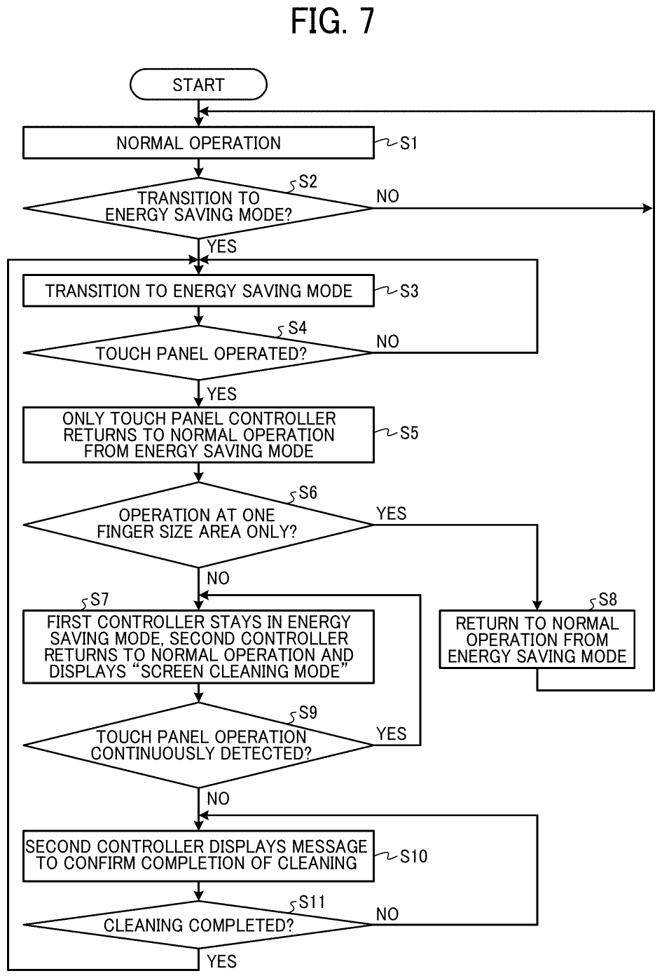

FIG. 7 is a flowchart illustrating the mode control operation executed mainly by the second controller 701. In steps S1 to S3 of this flowchart, when the normal image forming operation based on the scanner function or the printer function is not performed for a certain period of time or more, the energy saving mode transition control unit 801 stops energizing unnecessary parts and shifts to the energy saving mode.

In the energy saving mode, the second controller 701 is also put into a sleep state and the touch panel 940a detects only the presence or absence of a contact operation. In step S4, the contact operation detection unit 802 determines whether or not a contact operation is detected on the touch panel 940a when the second controller 701 is in the sleep state. In response to a detection of the contact operation on the touch panel 940a while the second controller 701 is in the sleep state (Yes in step S4), the return control unit 803 returns only the touch panel controller 707 of the control panel 2 to the operating state in step S5.

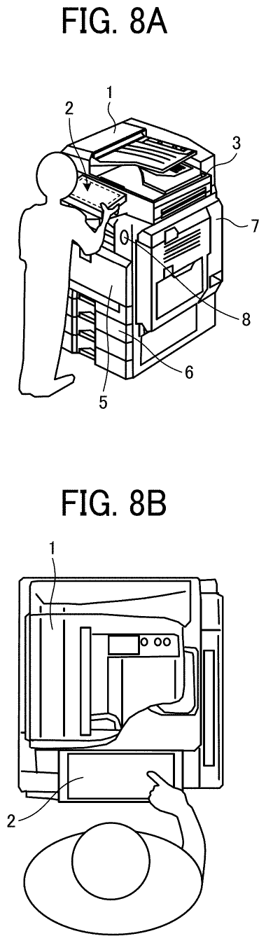

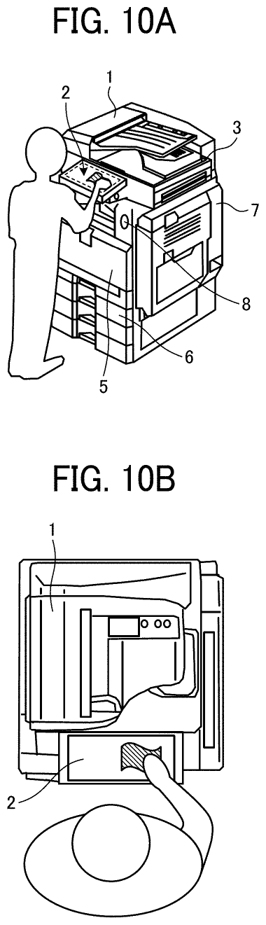

When returning the MFP 9 from the energy saving mode to the normal mode, the user moves in front of the MFP 9 as illustrated in FIG. 8A, and touches (operates) the control panel 2 in the off state with a finger or the like as illustrated in FIG. 8B. Further, when cleaning the touch panel 940a of the control panel 2 in the energy saving mode, the user moves in front of the MFP 9 as illustrated in FIG. 10A and cleans the control panel 2 in the off state by wiping the control panel 2 with a cloth or the like as illustrated in FIG. 10B.

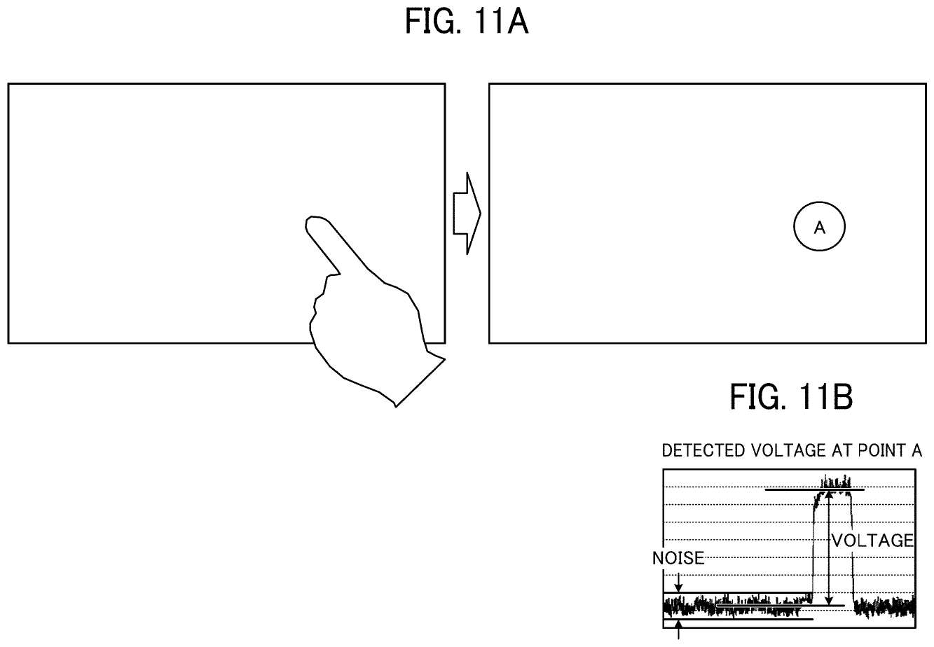

The contact operation when returning the MFP 9 from the energy saving mode to the normal mode is different from the contact operation when cleaning the touch panel 940a. FIG. 11 is a diagram illustrating a contact operation when returning the MFP 9 from the energy saving mode to the normal mode.

When returning the MFP 9 from the energy saving mode to the normal mode, the user usually touches the touch panel 940a with one finger as illustrated in FIG. 11A. When the touch panel 940a is touched with one finger, a narrow area of the touch panel is pressed, and as illustrated in FIG. 11B, a detected voltage at the pressed area is increased. In this case, since the detected voltage of the narrow area is increased, the contact operation detection unit 802 detects the contact operation as a “point” as illustrated by “A” in FIG. 11A.

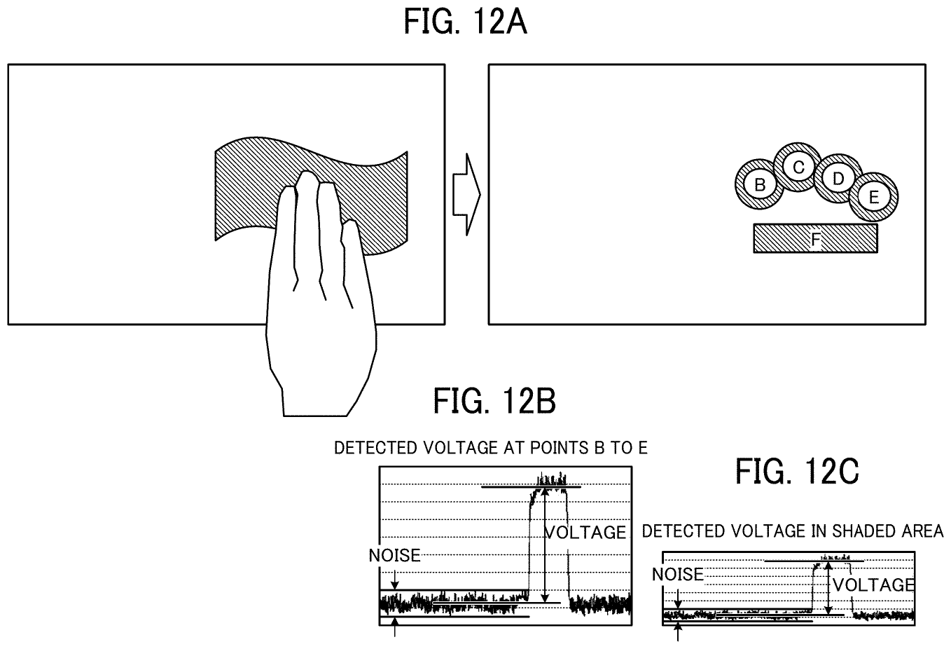

On the other hand, when cleaning the touch panel 940a as illustrated in FIG. 12A, the user's operation is to move the cloth or the like on the touch panel 940a with a plurality of fingers while moving the cloth or the like up, down, left and right to wipe off the foreign material on the touch panel 940a. In this case, the contact operation detection unit 802 detects the contact operation corresponding to each fingertip of an index finger, middle finger, ring finger and little finger, respectively, as illustrated as points “B” to “E” in FIG. 12B. At the same time, the contact operation detection unit 802 detects a wide square area “F” illustrated in FIG. 12B when the joints between the first joint and the second joint of the four fingers come into contact with the touch panel.

A high voltage is detected on the touch panel 940a by the contact operation of the fingertips of each finger as illustrated in FIG. 12B, and a medium voltage is detected on the touch panel 940a by the contact operation between the first joint and the second joint of each finger as illustrated in FIG. 12C.

In step S5, the touch panel controller 707 of the control panel 2 is returned to the operating state. In step 6, the contact operation detection unit 802 determines whether the operated “point” of the touch panel 940a is a single point of narrow area. As described with reference to FIGS. 11A and 11B, the contact operation of the single point of narrow area indicates that the user has touched the touch panel 940a with one finger. In this case, it is highly possible that the user has instructed to return from the energy saving mode to the normal mode. Therefore, the process proceeds from step S6 to step S8, and the return control unit 803 restarts the power supply to each unit that had the power supply stopped in the energy saving mode. As a result, the energy saving mode is returned to the normal mode.

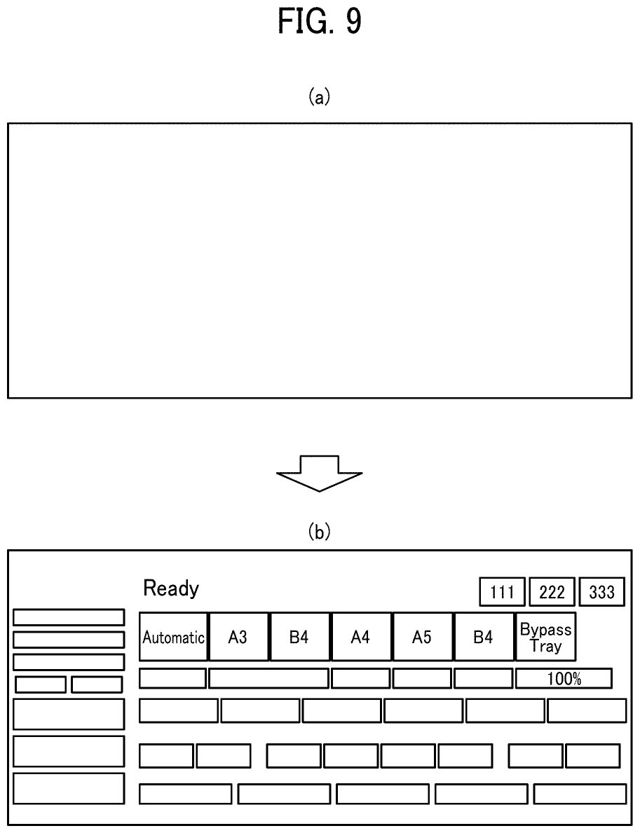

When returning from the energy saving mode to the normal mode, the display control unit 804 controls the LCD 706, which was in the off state as illustrated in FIG. 9(a) in the energy saving mode, to display the software keys for instructing the operation of each part as illustrated in FIG. 9(b). The user operates the software key displayed on the LCD 706 to instruct the desired operation of the MFP 9.

On the other hand, when the contact operation of the touch panel 940a is not the contact operation of the single point of narrow area (NO in step S6) and a contact operation at multiple points over wide area has been detected, there is a high possibility that the user is cleaning the touch panel 940a with a cloth or the like.

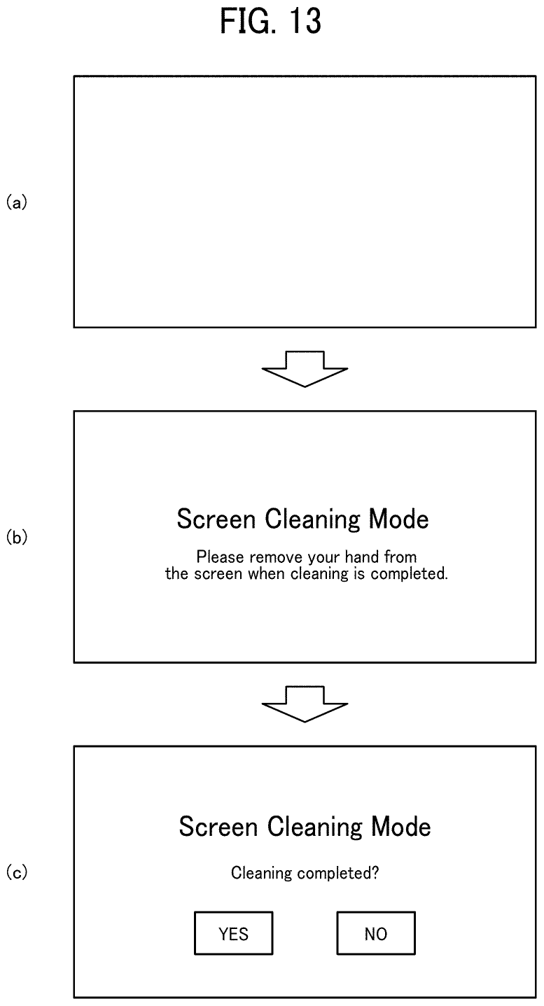

In this case, the return control unit 803 returns the second controller 701 of the control panel 2 to the operating state in step S7. Then, on the LCD 706, which was in the off state as illustrated in FIG. 13(a), the display control unit 804 displays a message indicating that the screen cleaning mode has been initiated, such as “Screen cleaning mode. Please remove your hand from the screen when cleaning is completed.”, as illustrated in FIG. 13(b). Such message display control is continuously executed in step S9 while the contact operation of multiple points in wide area is detected (YES in step S9).

The display control unit 804 displays the above-mentioned message, for example, at low brightness, or at an end such as the right end of the LCD 706, to ensure the visibility of the foreign material on the touch panel. As a result, it is possible to prevent the inconvenience that the foreign material on the touch panel becoming difficult to see due to the message.

If the LCD 706 is brightened during cleaning of the touch panel, it becomes difficult to visually recognize the foreign material adhering on the touch panel 940a. In the case of the MFP 9 according to the first embodiment, the above-mentioned message is displayed only on a part of the LCD 706 while the entire LCD 706 is maintained in the same state as the off state and the touch panel 940a can be cleaned without the difficulty in visually recognizing the foreign material.

Alternatively, the message may not be displayed. In this case, since the LCD 706 is turned off while the contact operation mode corresponding to the cleaning described with reference to FIG. 12 is detected, the touch panel 940a can be cleaned without the difficulty in visually recognizing the foreign material.

When the display control unit 804 determines in step S9 that the contact operation at multiple points in wide area is no longer detected (NO in step S9), in step S10, the display control unit 804 displays a message confirming the completion of cleaning such as “Screen cleaning mode. Cleaning completed? Yes No” on the LCD 706 as illustrated in FIG. 13(c).

If the cleaning is not completed, the user touches the display area of the character “NO”. When the cleaning is completed, the user touches the display area of the character “YES”. In step S11, the display control unit 804 determines whether the cleaning is completed (whether the user has touched the display area of the character “YES”). In this example, the completion of cleaning is input by operating the software key, but a hardware key may be used alternatively.

In response to detecting a contact operation in the display area of the character “NO” in step S11 which indicates that the cleaning has not been completed, the display control unit 804 displays the message illustrated in FIG. 13(b) on the LCD 706 again. Then, in step S9, when the contact operation at multiple points in wide area is not detected again, the message confirming the completion of cleaning illustrated in FIG. 13(c) is displayed on the LCD 706.

On the other hand, when the contact operation on the display area of the character “YES” is detected (YES in step S11), which indicates that the cleaning is completed, the process returns to step S3, and the energy saving mode transition control unit 801 stops the power supply to each unnecessary part and shifts the MFP 9 to the energy saving mode again.

As described above, when a contact operation on the touch panel 940a is detected in the energy saving mode, the MFP 9 according to the first embodiment determines whether the contact operation is a contact operation by cleaning the touch panel 940a or an operation instructing the operation of the MFP 9 (return to the normal mode). When the MFP 9 determines that the contact operation is the instruction to return to the normal mode, the MFP 9 is returned to the normal mode. Alternatively, when it is determined that the contact operation is performed by the cleaning, the energy saving mode is maintained without returning to the normal mode, and the foreign material adhering on the touch panel 940a can be easily recognized and the cleaning is assisted.

As a result, the touch panel 940a can be cleaned while the foreign material on the touch panel 940a in the energy saving mode is easily visible.

Hereinafter, a description is given of a second embodiment. In the first embodiment described above, the touch panel controller 707 of the control panel 2 is put into an operating state when the touch panel 940a is touched in the energy saving mode. The second embodiment described below is an example in which the touch panel controller 707 of the control panel 2 is set to the operating state when the user's approach to the MFP is detected by the motion sensor 8.

Note that only the above described point is different between the first embodiment and the second embodiment described below. For this reason, only difference is described below, and duplicated description is omitted.

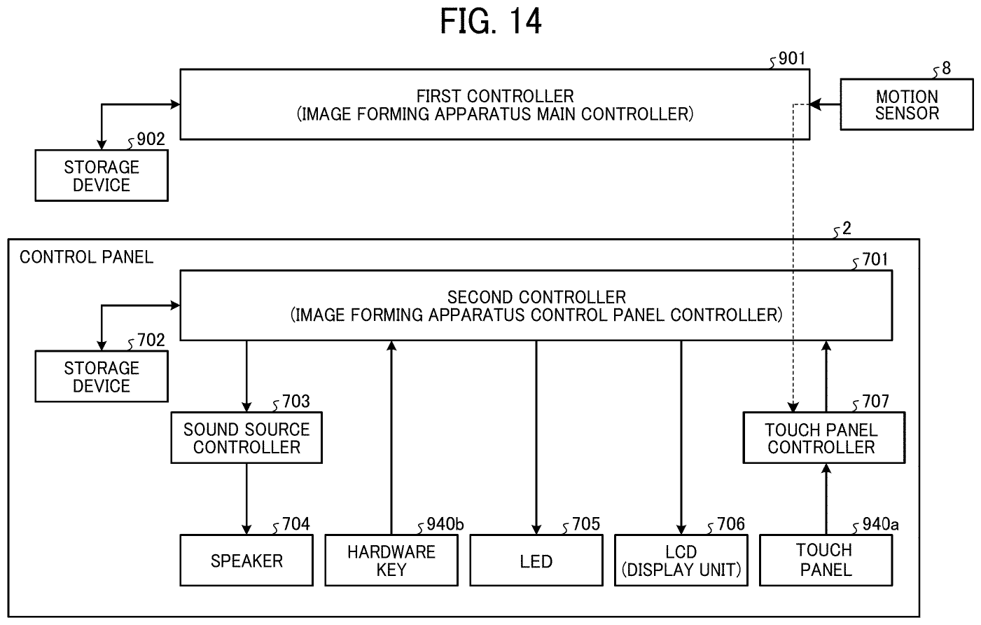

FIG. 14 is a block diagram illustrating a hardware configuration of the control panel 2 of the MFP 9 according to the second embodiment. As illustrated in FIG. 14, the motion sensor 8 provided in the MFP 9 transmits the detection output to the first controller 901 on the main body of the MFP 9. The first controller 901 transfers the detection output of the motion sensor 8 to the touch panel controller 707 of the control panel 2. In the energy saving mode, the touch panel controller 707 returns to the operating state by using the detection output from the motion sensor 8 as a trigger.

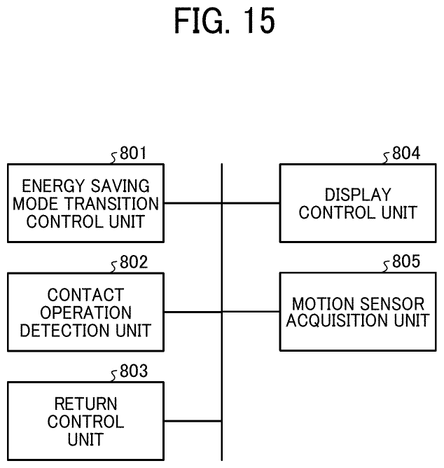

FIG. 15 is a block diagram illustrating a functional configuration of the second controller 701 of the control panel 2 according to the second embodiment. As illustrated in FIG. 15, in the case of the second embodiment, the second controller 701 includes a motion sensor acquisition unit 805 in addition to the above-described energy saving mode transition control unit 801, the contact operation detection unit 802, the return control unit 803, and the display control unit 804.

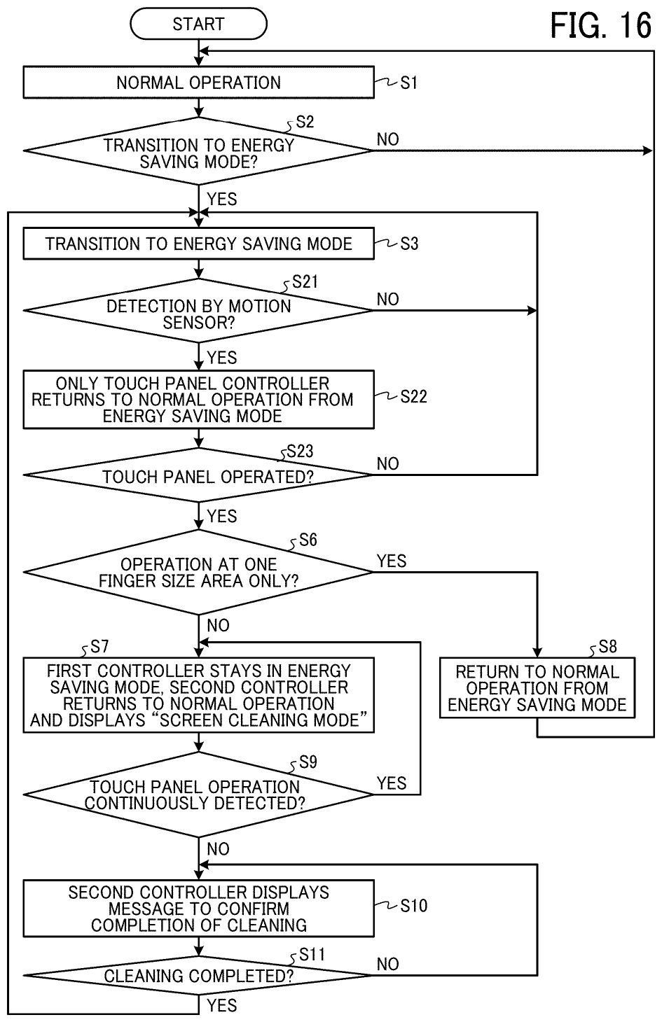

FIG. 16 is a flowchart illustrating a mode control operation executed by the second controller 701 according to the MFP 9 of the second embodiment. The flowchart illustrated in FIG. 16 is different from the flow chart of the first embodiment illustrated in FIG. 7 in that the processes of steps S21 to S23 based on the motion sensor are executed instead of steps S4 and S5 in the first embodiment.

When the energy saving mode transition control unit 801 shifts the entire MFP 9 to the energy saving mode in step S3 of the flowchart of FIG. 16, the motion sensor acquisition unit 805 acquiring the detection output from the motion sensor 8 in FIG. 15 determines in step S21 whether there is a detection output indicating an approach of the user to the MFP 9.

The detection output indicating the approach of the user to the MFP 9 is transmitted to the touch panel controller 707 as illustrated by a dotted line in FIG. 14. In step S22, the touch panel controller 707 returns to the operating state when the detection output indicating the approach of the user is transmitted.

The touch panel controller 707 that has returned to the operating state determines the operation mode of the touch operation of the touch panel 940a by the user, as described with reference to the flowchart of FIG. 7. That is, whether the user's contact operation is a contact operation for instructing the return to the normal mode (one-point contact operation) or a contact operation when the touch panel 940a is being cleaned is determined.

When the user's contact operation is the contact operation instructing the return to the normal mode, the return control unit 803 restarts each part of the MFP 9 to return to the normal mode in steps S6 and S8.

On the other hand, when the user's contact operation is the contact operation indicating cleaning of the touch panel 940a, the display control unit 804 displays on the LCD 706, a message indicating that the screen cleaning mode is currently in progress while maintaining the energy saving mode and without interfering the visibility of foreign material.

This makes it possible to clean the touch panel 940a in the energy saving mode where foreign material on the touch panel is easily visible, and the same effect as that of the first embodiment described above can be obtained.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

1. A control panel comprising:
a display configured to display an operation screen for operating a device;
a touch panel configured to detect a contact operation on the operation screen; and
circuitry configured to:
determine whether a contact operation performed on the operation screen in an energy saving mode in which power supply to a part of the control panel is stopped, is a contact operation for instructing a return from the energy saving mode to a normal mode for operating the device, or a contact operation for cleaning the touch panel;
based on a determination that the contact operation is a contact operation for instructing the return to the normal mode, display the operation screen and return the device to an operating state; and
based on a determination that the contact operation is a contact operation for cleaning foreign material on the touch panel, maintain a non-display state of the operation screen.

2. The control panel of claim 1, wherein the circuitry is configured to:
determine one-point contact operation on the operation screen as the contact operation for instructing the return to the normal mode; and
determine multiple points contact operation in a wide area as the contact operation for cleaning the touch panel.

3. The control panel of claim 1, wherein the circuitry is further configured to display on the display, an operation screen indicating that the touch panel is in a screen cleaning mode in a display form that does not interfere visibility of foreign material on the touch panel, based on the determination that the contact operation is a contact operation for cleaning.

4. The control panel of claim 1, wherein
the circuitry is further configured to return the device to the energy saving mode in response to detecting an operation indicating completion of cleaning of the touch panel.

5. The control panel of claim 1, wherein the control panel is mounted on the device including a motion sensor; and
the circuitry is further configured to determine whether a contact operation is the contact operation for instructing the return from the energy saving mode to the normal mode or the contact operation for cleaning the touch panel, based on a detection output by the motion sensor indicating a distance of user to the device in the energy saving mode.

6. An image forming apparatus comprising:
a display configured to display an operation screen for operating the image forming apparatus;
a touch panel configured to detect a contact operation on the operation screen;
an image forming device configured to form an image; and
circuitry configured to:
determine whether a contact operation performed on the operation screen in an energy saving mode in which power supply to a part of the image forming apparatus is stopped, is a contact operation for instructing a return from the energy saving mode to a normal mode for operating the image forming apparatus, or a contact operation for cleaning the control panel;
based on a determination that the contact operation is a contact operation for instructing the return to the normal mode, display the operation screen and return the image forming apparatus to an operating state; and
based on a determination that the contact operation is a contact operation for cleaning foreign material on the touch panel, maintain a non-display state of the operation screen.

7. The image forming apparatus of claim 6, wherein the circuitry is configured to:
detect one-point contact operation on the operation screen as the contact operation for instructing the return to the normal mode; and
detect multiple points contact operation in a wide area as the contact operation for cleaning the touch panel.

8. The image forming apparatus of claim 6, wherein
the circuitry is further configured to display on the display, an operation screen indicating that the touch panel is in a screen cleaning mode in a display form that does not interfere visibility of foreign material on the touch panel, based on the determination that the contact operation is a contact operation for cleaning.

9. The image forming apparatus of claim 6, wherein
the circuitry is further configured to return the image forming apparatus to the energy saving mode in response to detecting an operation indicating completion of cleaning of the touch panel.

10. The image forming apparatus of claim 6, further comprising a motion sensor, and
wherein the circuitry is further configured to determine whether a contact operation is the contact operation for instructing the return from the energy saving mode to the normal mode or the contact operation for cleaning the touch panel, based on a detection output by the motion sensor indicating a distance of user to the image forming apparatus in the energy saving mode.

11. A non-transitory recording medium which, when executed by one or more processors, cause the processors to perform a mode control method comprising:
determining whether a contact operation performed on an operation screen for operating a device in an energy saving mode in which power supply to a part of the device is stopped, is a contact operation for instructing a return from the energy saving mode to a normal mode for operating the device, or a contact operation for cleaning a touch panel that detects the contact operation on the operation screen;
based on a determination that the contact operation is a contact operation for instructing the return to the normal mode, displaying the operation screen, and returning the device to an operating state; and
based on a determination that the contact operation is a contact operation for cleaning foreign material on the touch panel, maintaining a non-display state of the operation screen.
